(19) United States
(12) Patent Application Publication
(10) Pub. No.: US 2005/0277094 A1
(43) Pub. Date: Dec. 15, 2005

(54) System and method to teach reading

(76) Inventor: Karen L. Davidson, Port Orchard, WA (US)

Correspondence Address: KAREN LOUISE DAVIDSON, 16000 WILLOW ROAD SE, PORT ORCHARD, WA, 98367, US

(21) Appl. No.: 10/856,687

(22) Filed: May 28, 2004

(51) Int. Cl. G09B 1/00

(52) U.S. Cl. 434/167; 434/169; 434/323

(57) ABSTRACT

A system and method to teach reading by ranking the prevalence level of alphabet letter sounds as number phonics to alphabet letter words, associating pronunciation and voice emphasis codes to the number phonics, associating the number phonics to the alphabet letters of words, and speaking the word by blending the sequence of the number phonics pronunciation and voice emphasis codes associated with the alphabet letters of the words.

### FIELD OF THE INVENTION

This invention relates generally to phonic-based reading system and method.

### BACKGROUND OF THE INVENTION

Reading systems and methods include phonic based systems and non-phonic based systems. Phonics can be defined as the means of recognizing printed words by knowing and saying aloud the sounds that the letters of words represent. However, as traditionally taught, phonics is deficient for several reasons: (1) many English alphabet letters represent more sounds than are normally taught by traditional methods, so students become confused when they need to master words with sounds they have not learned; (2) conventional rules that are taught do not work for every word; and (3) the insufficient ranking of the frequency of sound-letter relationships by usage prevalence has hampered the student's learning efficiency as the student cannot prioritize to which words having the greater prevalence speech sounds. Non-phonic based systems that teachers have employed include several approaches for teaching word recognition. These include (1) making sensible guesses at words using beginning letters of the words as prompts, (2) looking about the page for pictures or other clues that reveal the words, and (3) memorizing words as whole entities by the shape or patterns of the letters within the words. Both traditional phonics and non-phonic systems have resulted in beginning readers becoming frustrated and having to employ reading specialists.

Thus, there is a need for a system and method to teach reading that more completely catalogs the repertoire of alphabet letter speech sound relationships, in arranging for pronunciations of the cataloged speech sound relationships in a systematic manner to more easily teach or self-teach the reading student, and in assisting the student to decipher and correctly pronounce the words of selected texts.

### SUMMARY OF THE INVENTION

The invention is an improved system and method to enhance reading and the speaking of English language words by more thoroughly establishing the variety of speech sounds associated with the alphabet letters, arranging or the distributing the speech sound relationships to by use frequency or prevalence level to assist the student in prioritizing study efforts to those words having high, medium, and low prevalence level sounds. The system and method may be self-taught by a user or applied by a teacher to a single or multiple students so that the student has the ability to decipher and pronounce the sounding of words in reading materials.

The system and method teaches reading by ranking the prevalence level of alphabet letter sounds as number phonics to alphabet letter words. Pronunciation and voice emphasis codes are associated with the number phonics. The number phonics are in turn associated with the alphabet letters of words. The speaking of words is accomplished by blending the sequence of the number phonics' pronunciation and voice emphasis codes associated with the alphabet letters of the words.

The speech sound relationships are categorized in order of numeric prevalence with the alphabet letter. This categorization of the usage frequency or prevalence of the speech sound is designated in alphanumerical terms defined as number phonics. A pronunciation and voice emphasis code is defined for each number phonic of the alphabet letter and is conveyed by pronunciation keys provided by model words. The number phonics are associated with the letters of words selected for study. The selected words are then spoken in order of the word's associated pronunciation and voice emphasis codes as defined by the number phonic. The speaking of the words are practiced by the sequence of pronunciation and voice emphasis codes in sequence with the letter order of the word and blended. Thereafter the system and method is applied to words of selected reading texts.

### BRIEF DESCRIPTION OF THE DRAWINGS

The preferred and alternative embodiments of the present invention are described in detail below with reference to the following drawings.

FIG. 1 is an overview of the method of the invention;

FIG. 2A shows the development of speech sound distributions by prevalence level for each alphabet letter.

FIG. 2B shows the completion of speech sound distributions throughout all prevalence levels for each alphabet letter.

FIG. 3 is an expansion of the step 120 of FIG. 1;

FIG. 4A shows the assignment of pronunciation and voice emphasis codes by prevalence level for each letter of the alphabet;

FIG. 4B shows a further assignment of pronunciation and voice emphasis codes to the letter sound symbols;

FIG. 4C is a more thorough listing of the pronunciation and voice emphasis codes for letters A through E;

FIG. 4D is a more thorough listing of the pronunciation and voice emphasis codes for letters F through N;

FIG. 4E is a more thorough listing of the pronunciation and voice emphasis codes for letters O through S;

FIG. 4F is a more thorough listing of the pronunciation and voice emphasis codes for letters T through Z;

FIG. 5 is an expansion of steps 140 and 160 of FIG. 1;

FIG. 6 is an example of step 142 of FIG. 5;

FIG. 7A depicts word examples having prevalence level 1 sounds;

FIG. 7B depicts word examples having prevalence levels 1 and 2 sounds;

FIG. 7C depicts word examples having prevalence levels 1, 2, and 3 sounds;

FIG. 7D depicts word examples having prevalence levels 1-8 sounds;

FIG. 7E depicts word examples of the eighth prevalence level for the number phonic O-8 of the alphabet letter O;

FIG. 8A depicts word examples of the ninth prevalence level for the number phonic E-9 of the alphabet letter E;

FIG. 8B depicts a word example of the ninth prevalence level for the number phonic O-9 of the alphabet letter O;

FIG. 9 is a flow diagram of a self-taught user system to teach reading;

FIG. 10 is a flow diagram of a student-teacher system to teach reading; and

FIG. 11 is a block diagram of the system to teach reading using multiple embodiments.

### DETAILED DESCRIPTION OF THE PREFERRED EMBODIMENT

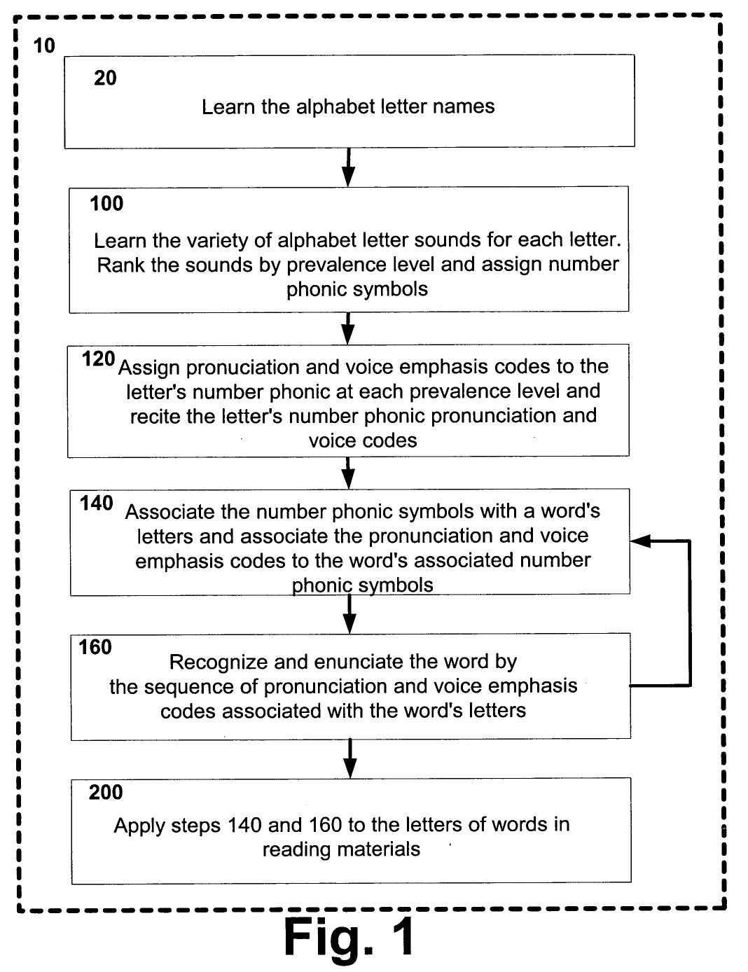

The overview of a preferred embodiment of the reading method is shown in FIG. 1. The reading method 10 begins at step 20 by learning the 26 alphabet letter names of the English alphabet. At step 100 the variety of alphabet letter sounds are determined for each letter. The ranking of the sounds by distribution or prevalence level is determined and alphanumeric symbols are assigned. Thereafter, at step 120, pronunciation codes are assigned to the letter's alphanumeric sound symbols. Following step 120 is step 140 where the alphanumeric symbols are associated with a word's letters and the pronunciation codes is similarly associated with the alphanumeric symbols that have been associated with a word's letters. Thereafter, at step 160, a selected word is recognized and enunciated by the sequence of pronunciation and voice emphasis codes assigned to, and in order of the word's letters. Finally, steps 140 and 160 are repeated as necessary to learn a repertoire of words. Thereafter, the reading method is applied to selected reading texts.

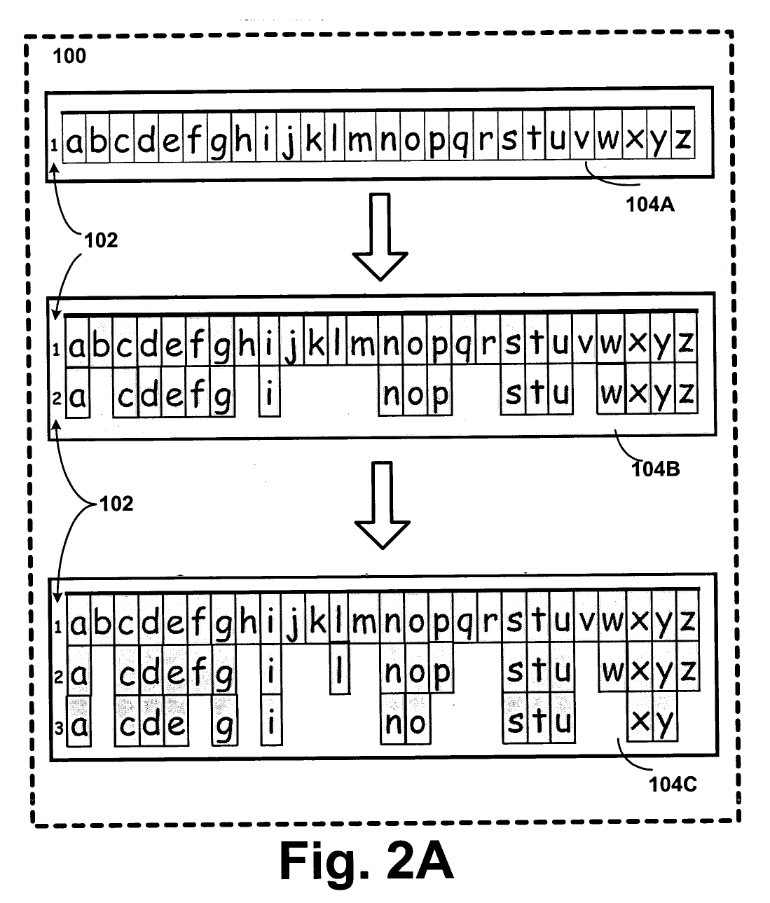

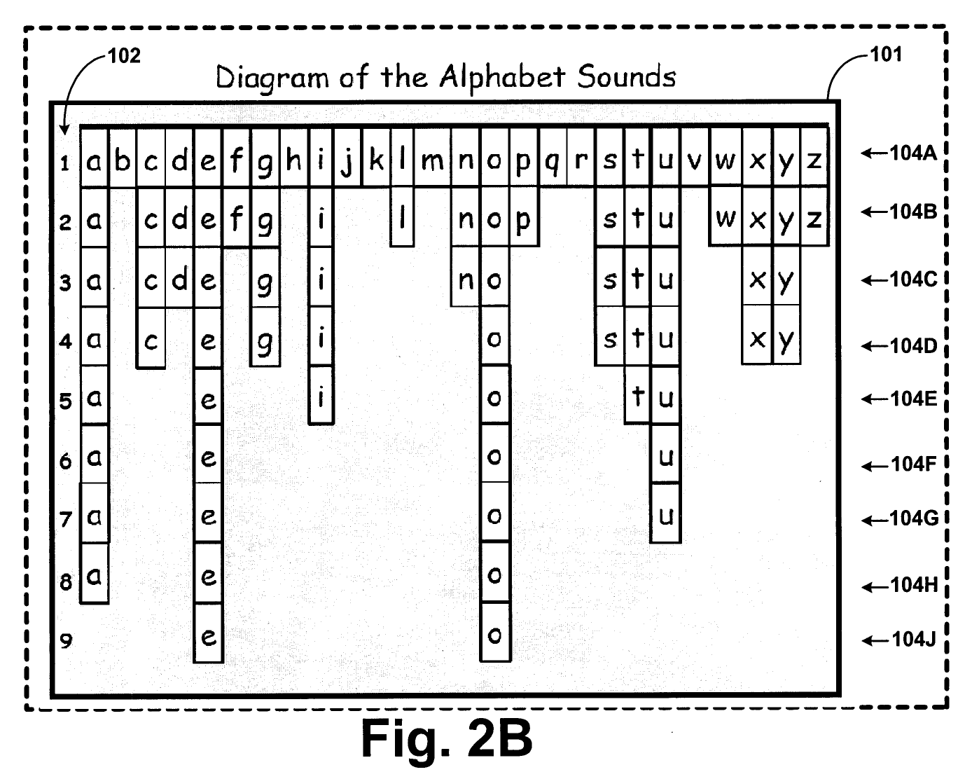

FIG. 2A shows the development of speech sound distributions by prevalence level for each alphabet letter in a speech level diagram 101. The first prevalence level 102 is prevalence level 1 and includes all alphabet letters a-z. The first level 1 presents the alphabet letters listed and from A to Z as a first alphabet row 104A. The first alphabet row 104A presents a primary sound level of all twenty six alphabet letters. The next sequence shows a second distribution of letters in which not every letter of the alphabet is listed. In this particular case, letters A, C, D, E, F, G, I, L, N, O, P, S, T, U, and W, X, Y, Z are listed in level 2 for a second alphabet row 104B. The second alphabet row 104B presents a second sound level for 18 of the 26 alphabet letters. At 104C is the third prevalence level in which the distribution of letter decreases to alphabet letters A, C, D, E, G, I, N, O, S, T, U, X, and Y are shown in a third alphabet row 104C. The third alphabet row 104C presents a third sound level for 13 of the 26 alphabet letters.

FIG. 2B is a table showing the completion of the distribution of sound levels or prevalence levels 102. There are nine prevalence or sound levels 102, 1 through 9, for the alphabet letters. The relative distribution of sounds for the alphabet letters by prevalence level 102 is easily seen wherein an increase in prevalence level number denotes a decrease in speech sound occurrence for a given alphabet letter. As can be seen, the number of alphabet letters having speech sounds decrease in an inverse relationship to the prevalence level number. Continuing with the fourth prevalence level, a fourth alphabet row 104D lists 11 of the 26 alphabet letters. In decreasing proportion at prevalence level 5, a fifth alphabet row 104E lists six of the alphabet letters. At prevalence level 6, a sixth alphabet row 104F line lists four alphabet letters. For prevalence level 7, a seventh alphabet row 104G list four alphabet letters. For prevalence level 8, an eight alphabet row 104H list 2 alphabet letters. Finally, for prevalence level 9, a ninth alphabet row 104J similarly lists two alphabet letters.

The table in FIG. 2B is used by the reading student as a visual study aid to cue the student to sound out the pronunciation and voice coeds that are associated a given alphabet letter's position occupying the prevalence level 102 for alphabet rows 104A-J. Alternate embodiments of the table in FIG. 2B are possible for serving as a study guide cues. For example, an individual letter or a partial to complete list of alphabet letters circumscribed by dots, each dot representing the number of letter sounds for a given alphabet letter represents a non-tabular embodiment. Another non-tabular embodiment serving as a drilling cue would be represented by individual letters, partial lists, or complete alphabet listing of letters circumscribed by the prevalence level numbers 102. For example, the alphabet letter “a” would be circumscribed by numbers 1-7. The letter “e” would be circumscribed by numbers 1-9.

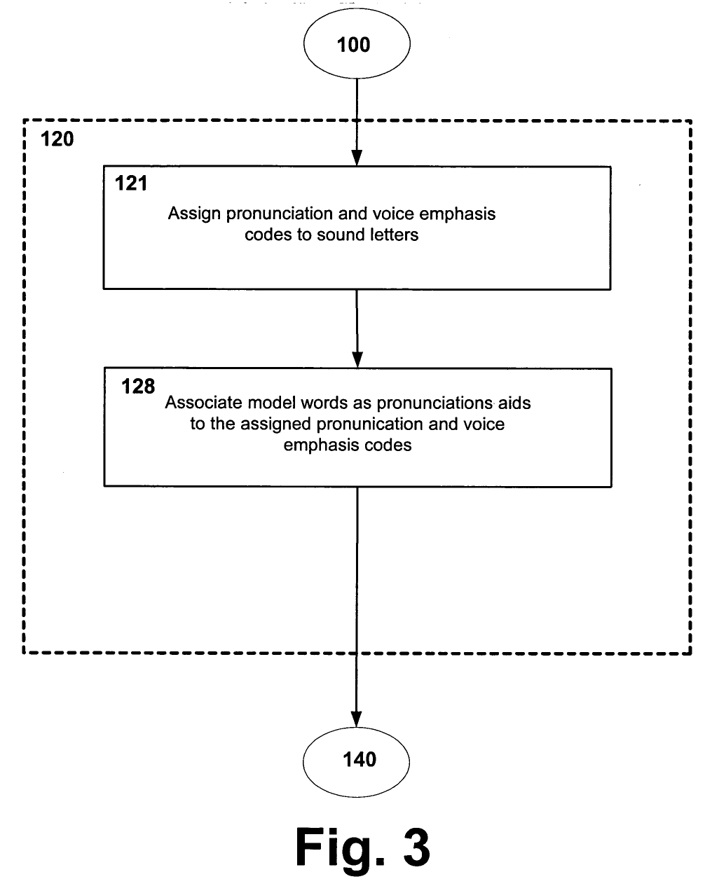

FIG. 3 is an expansion of the step 120 of FIG. 1. Step 120 includes step 121 where alphabet row listings are assigning pronunciation and voice emphasis codes. Thereafter, at step 128, model words are assigned as pronunciation aids to the assigned pronunciation and voice emphasis codes.

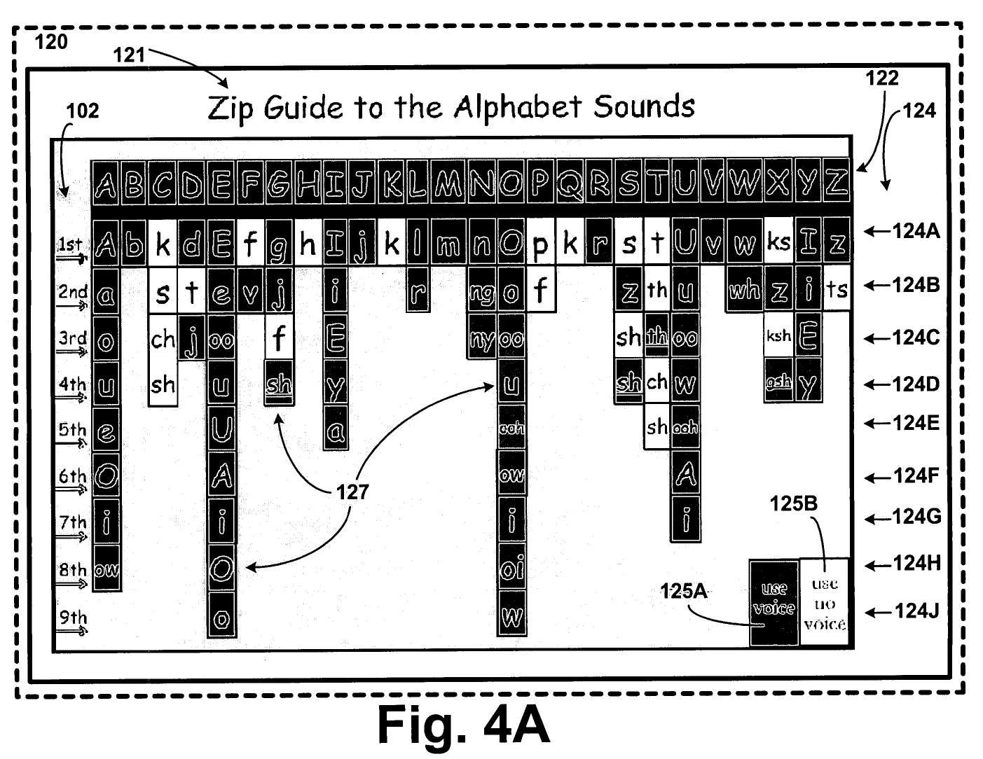

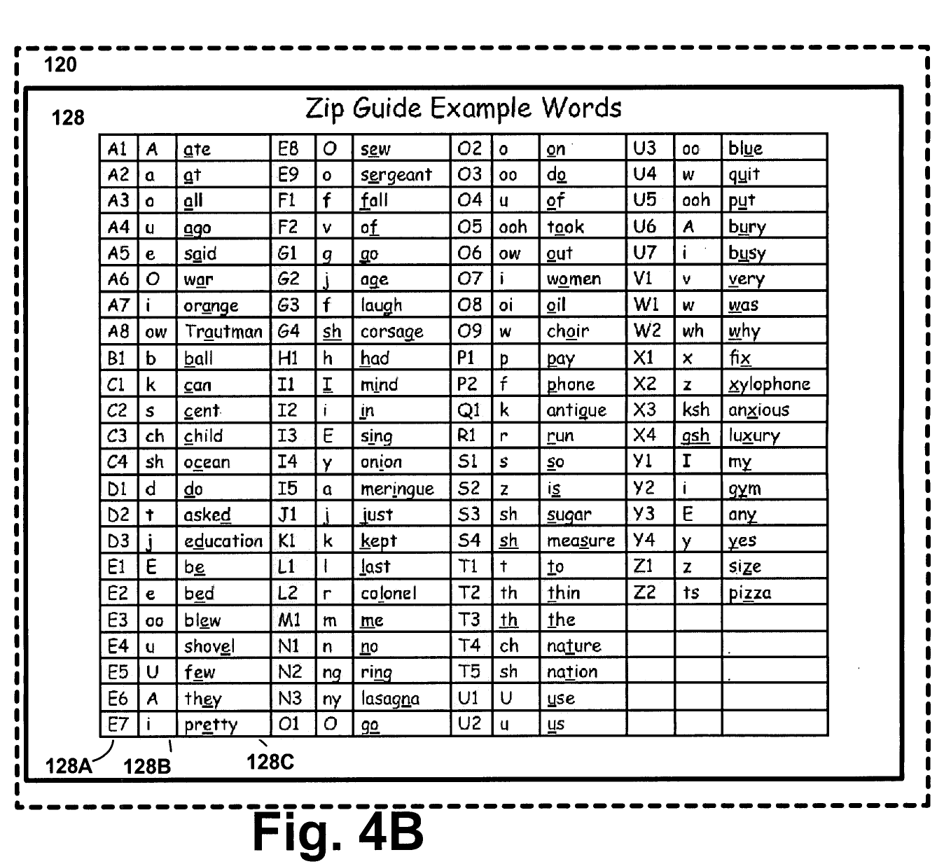

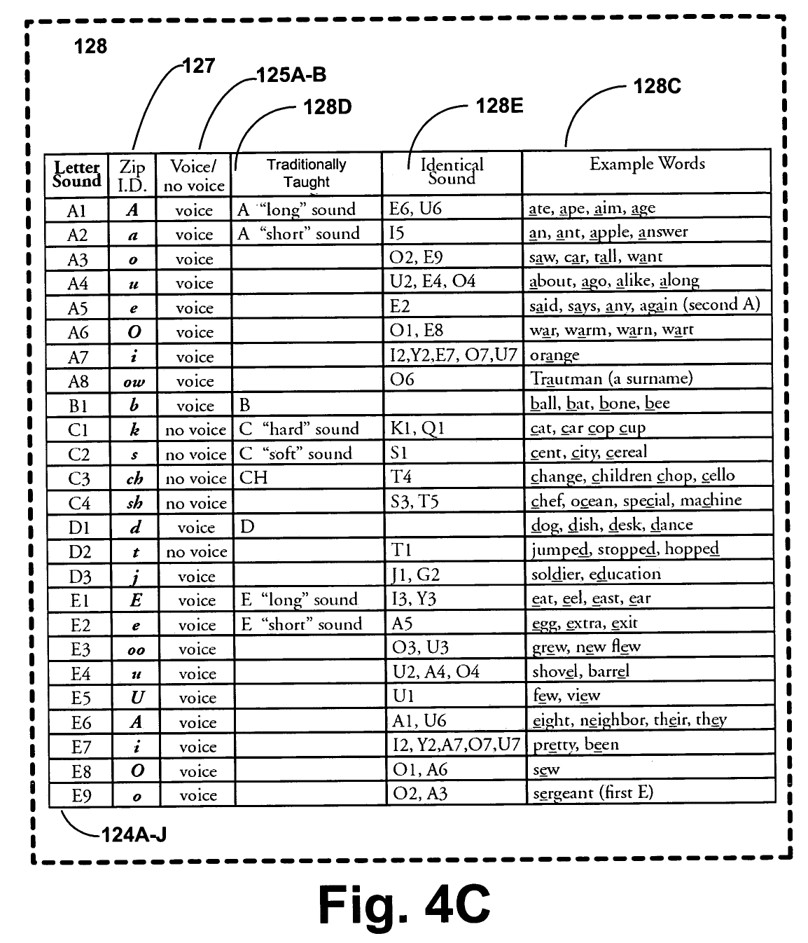

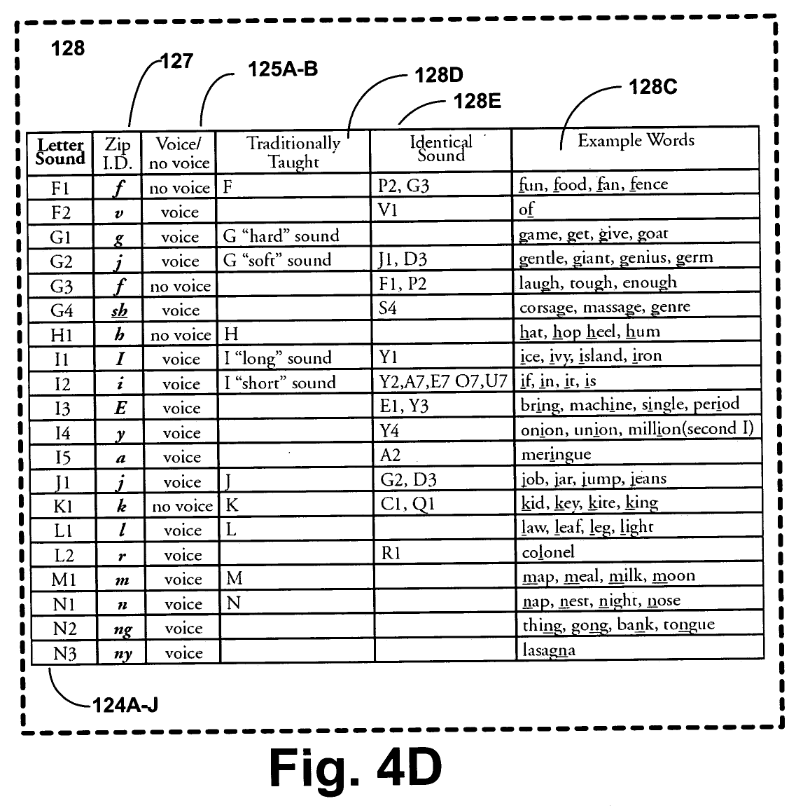

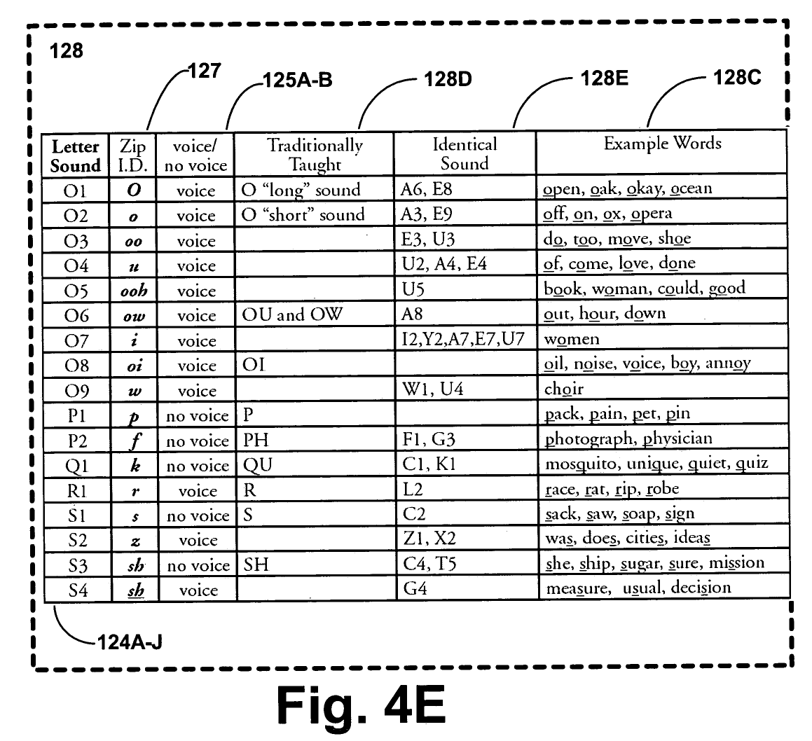

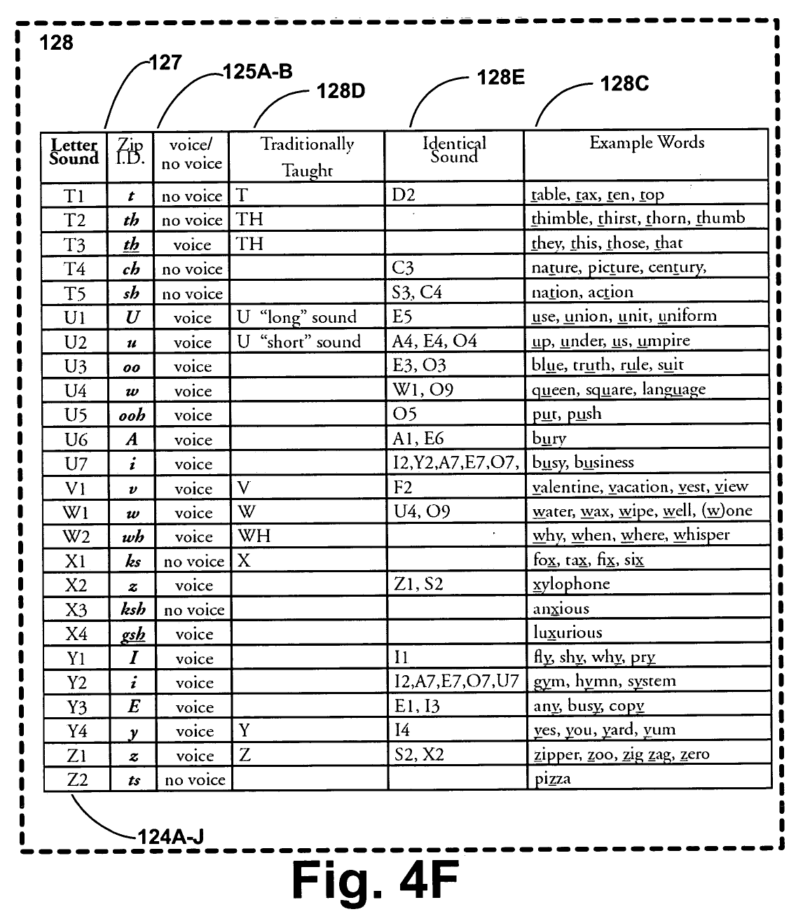

FIG. 4A is an expansion of step 120 and shows assignment of pronunciation and voice emphasis codes to the letters of each alphabet rows. As shown in “A Zip Guide to the Alphabet Sounds” 121, a repertoire of 87 speech sounds are incorporated into the alphabet rows 104A-J depicted in FIG. 2B for the nine prevalence levels 102. Beneath an alphabet name row 122 is a tabulation of prevalence levels 102 with a speech sound row 124. For every alphabet row 104, there is a corresponding speech sound row 124. Thus with alphabet rows 104A-J there corresponds speech sound rows 124A-J.

The repertoire of the 87 alphabet letter speech sounds are distributed through the Zip Guide 121 in high, middle, and low prevalence groups. For example, 1-3 prevalence levels 102 represents the high prevalence level group and includes 57 of the 87 alphabet letter speech sounds. That is approximately 66% of the Zip Guide 121 sounds. The middle prevalence group is represented by 4-6 prevalence levels 102 and includes 21 of the 87 alphabet letter speech sounds, or approximately 24% of the Zip Guide 121 sounds. The low prevalence group is represented by 7-9 prevalence levels 102 and includes 9 of the 87 alphabet letter speech sounds, or approximately 10% of the Zip Guide 121 sounds.

The pronunciation codes are shown inserted within intersection cells of the prevalence level number and alphabet letter name. The cells have the pronunciation delineated in it and for convenience is referred to as a ZIP identification 127 or ZIP ID 127. For example, beneath the alphabet name row 122 for the first prevalence level 102, the pronunciation code “A” from the first speech sound row 124A is placed beneath the letter “A” of the name row 122. Pronunciation code “b” from the first speech sound row 124A is placed beneath the letter “B” of the name row 122. Pronunciation code “k” from the first speech sound row 124A is placed beneath the letter “C” of the name row 122. Another example depicts pronunciation code “ks” from the first speech sound row 124A placed beneath the letter “X” of the name row 122. Similarly, pronunciation code “ooh” from the fifth speech sound row 124E is placed beneath the letter “O” and pronunciation code “sh” is placed beneath the letter “T” of the name row 122.

Shown also in the Zip Guide 121 are voice emphasis codes presented in color-coded legends. The voice emphasis codes include a “use voice” code 125 A and a “use no voice” code 125B. The “use voice” code 125A is applied for strong-sounding letters pronounced by substantially resonating vocal cords. The “use no voice” code 125B is applied for soft sounding letters pronounced by substantially non-resonating vocal cords where the air is expelled past the vocal cords without causing significant vocal cord vibrations. The use voice code 125A is depicted in a gray tone legend, and the use no voice code 128B is depicted in white tone legend. Alternate embodiments for the voice emphasis codes may be identified legends other than gray and white. For example, by colors or symbols, wherein different colors or symbols are used to distinguish “use voice” code 125A and “no voice” code 125B.

The “use voice” code 125A is applied for strong-sounding letters represented by the vowels A, E, I, O, U at all prevalence levels; the letter B; the letter D at prevalence levels 1 and 3; the letter F at prevalence letter 2; the letter G at levels 1, 2, and 4; the letter J at level 1; the letter L at levels 1 and 2; the letter M at level 1; the letter N at levels 1, 2, and 3; the letter R at level 1; the letter S at levels 2 and 4; the letter T at levels 3; the letter V at level 1; the letter W at levels 1 and 2; the letter W at levels 1 and 2; the letter Y at levels 1-4; and the letter Z at level 1. The “use voice” code 125A employs a range of resonations in the vocal cords of the students and teachers so that there is a variation in enunciation strength.

The “use no voice” code 125B is applied to soft-sounding letters represented by the letter C at prevalence levels 1-4; the letter F at level 2; the letter H at level 1; the letter K at level 1; the letter P at levels 1 and 2; the letter Q at level 1; the letter S at levels 1 and 3; the letter T at levels 1, 2, 4, and 5; the letter X at levels 1 and 3; and the letter Z at level 2.

As shown in FIG. 4A, the eight sounds for the letter “A” have eight pronunciation codes and one voice code (“use voice”). The eight sounds for alphabet letter A are “A”, “a”, “o”, “u”, “e”, “O”, i and “ow”. There is one pronunciation code and one voice code (“voice” 125A) for the single sound of letter “B”, and four pronunciation codes (“k”, “s”, “ch”, and “sh”) and one voice code (“no voice” 125B) for alphabet letter C. There are three pronunciation codes “d”, “t”, “j” and two voice codes (voice for “d” and “j” and no voice for “t”). Other examples include four pronunciation codes “g”, “j”, “f” and “sh” and two voice codes (voice for “g” and “j”, no voice for “f”, and use voice for “sh”) for the alphabet letter G. Note that for the “sh” pronunciation sound in the alphabet letter C is not underlined to further delineate that a no voice 125B emphasis is employed, whereas the “sh” pronunciation sound in the alphabet letter G is underlined to further delineate and emphasize that a use voice 125A emphasis is employed.

As further shown in FIG. 4A, some alphabet letters have only one sound. For example, the alphabet letters B, H, J, K, M, Q, R, and V have only one speech sound at the first prevalence level. Whereas the letter E and O have nine prevalence level sounds.

The sound letter relationships for the pronunciation and voice codes for each alphabet letter may be expressed in alphanumeric terms in the format “alphabet letter-prevalence level”. For example, the alphabet letter “A” has eight sound letters conveniently designated as number phonics A-1, A-2, A-3, A-4, A-5, A-6, A-6, and A-8. Similarly, the alphabet letter “O” has nine sounds letters conveniently designated as number phonics O-1, O-2, O-3, O-4, O-5, O-6, O-7, O-8, and O-9.

FIG. 4B depicts a more complete pronunciation code and includes model words as pronunciation aids for the sound letters. A number phonic column 128A list the sound letters of the alphabet letters expressed in the alphanumeric number phonic format. A second column 128B lists the pronunciation codes or ZIP ID 127 from the speech sound rows 124A-J. A third column 128C shows a model word or an example word to function as a pronunciation aid for the pronunciation code. For example, a model word “ate” is used for the pronunciation code “A” for sound A-1. Another model word “education” is used for the pronunciation code “j” for sound D-3. Yet another model work is “xylophone” used for pronunciation code “z” for sound X-2, and so on.

FIG. 4C shows an expanded compilation of the ZIP I.D. pronunciation codes 127, voice codes 125A-B, and model words 128C for sound letters A-1 through E-9. For example, model words for sound E-6 are “eight, neighbor, their, and they”. FIG. 4D is similarly an expansion of FIG. 4A for sound letters F-1 through N-3. FIG. 4E is an expansion for the sound letters O-1 through S-4. FIG. 4F is an expansion of the model words for the sound letter sounds T-1 through Z-2. Also shown in FIGS. 4C-F is a Traditionally Taught column 128D showing the conventional pronunciation code designations. By comparison, an Identical Sound column 128E is adjacent to the Traditionally Taught column 128D and clearly shows the extra sounds employed by the method 10 of the invention. Additionally the Identical Sound column 128E groups the number phonics obtained from the speech sound rows 124A-J and column 128A from the Zip Guide 121 into substantially similar sound groups for a given number phonic. For example, in FIG. 4C, the Zip ID 127 “i” sound for number phonic A-7 has as substantially similar sound groupings (Identical Sound 128E) of number phonics 1-2, Y-2, E-7, O-7, and U-7.

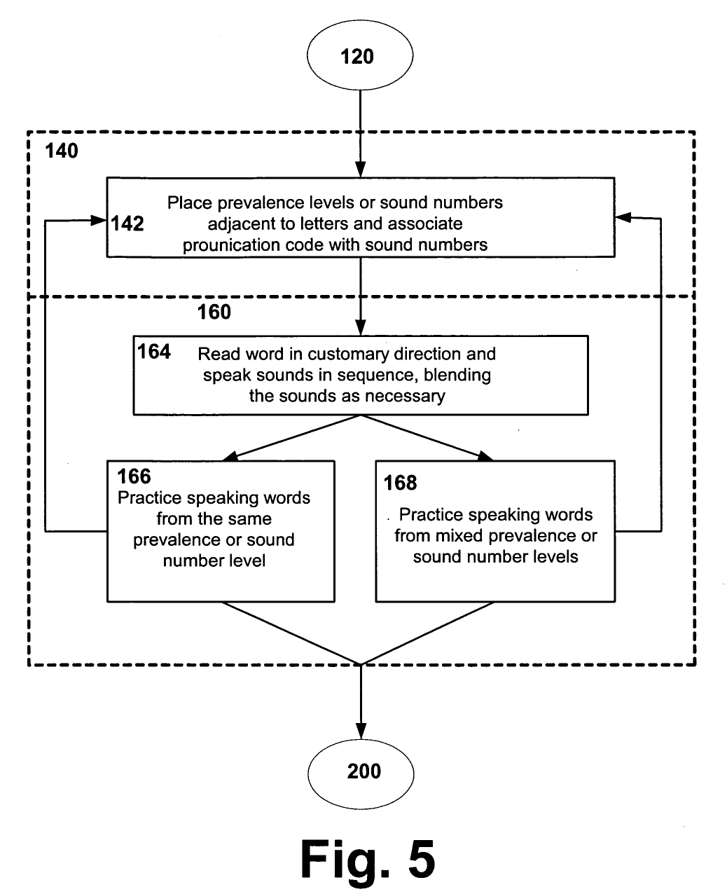

FIG. 5 is an expansion of steps 140 and 160 of FIG. 1. In step 140, where the alphanumeric numbers are associated with letters of the word and the pronunciation code is associated with alphanumeric symbols, is more thoroughly described in step 142 where the prevalence levels or sound numbers are placed adjacent to the letters and the pronunciation code are associated with the prevalence level numbers. Thereafter, step 160, begins with step 164 where the word is read in a customary direction of English words being read from left to right and the sounds are spoken in sequence with the pronunciation code associated with the prevalence level. The sequence of sounds are blended as necessary in the letter order of the word. From step 164, the student has an option to either at step 166, practicing speaking the words from the same prevalence or sound number level, or at step 168, the student can practice speaking words from mixed prevalence or sound number levels. Thereafter, from step 166, the student may return to step 142, to begin anew with different words as similarly from step 168 also returned to step 142 to begin with new words. Once practice is completed, the student may then go on to step 200 to apply this method in book reading.

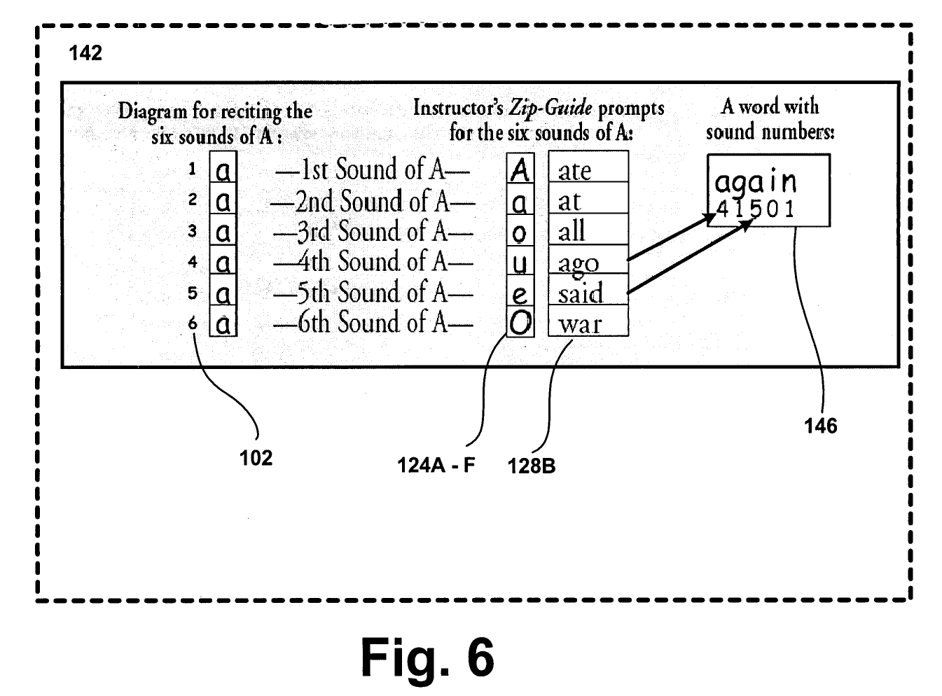

FIG. 6 is an expansion of step 142 of FIG. 5. In FIG. 6 is seen the reciting of the six sounds of letter A at the first, second, third, fourth, fifth, and sixth prevalence levels 102. The zip guide lists the pronunciation letters for the first through seven sound levels for letter A in 124 A-G. The example words 128B is respectively listed as words “ate”, “at”, “all”, “ago”, “said”, and “war”. The pronunciation codes are associated with the prevalence levels which are written under the word “again” 146 as the respective numbers 41501 where “ago” is associated with the first letter “A” of the word “again” as prevalence level 4 and the second letter “A” of the word “again” prevalence level 5. Such that again is the first letter “A” is spoken with “ago” and the second letter “A” is spoken with “war”.

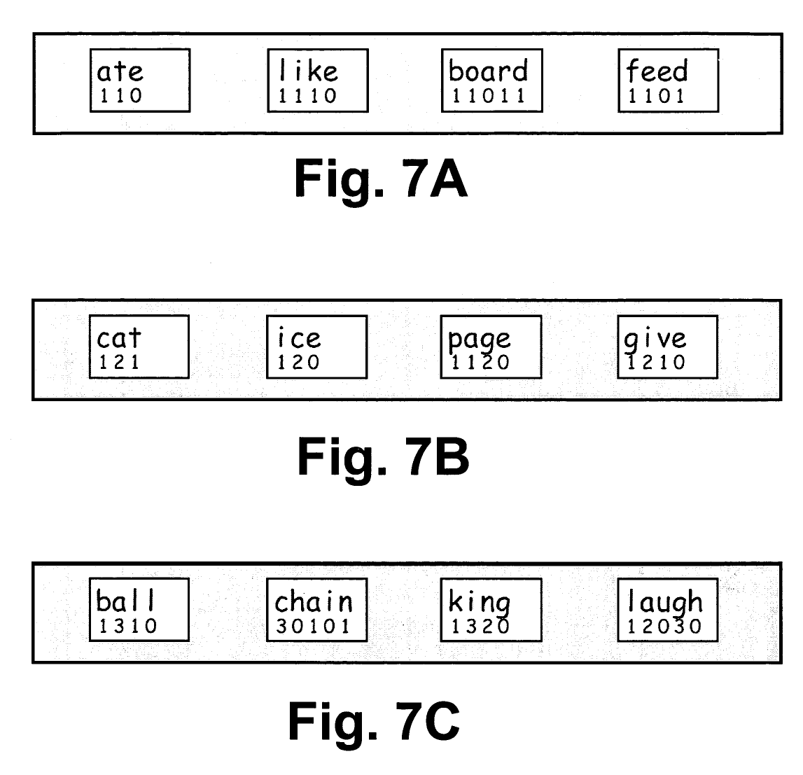

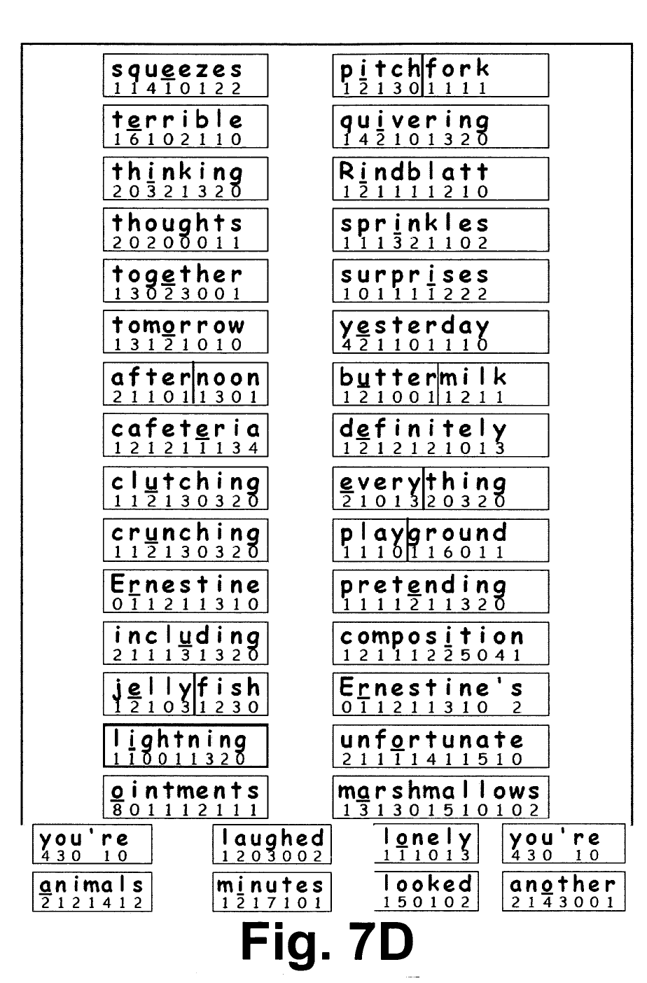

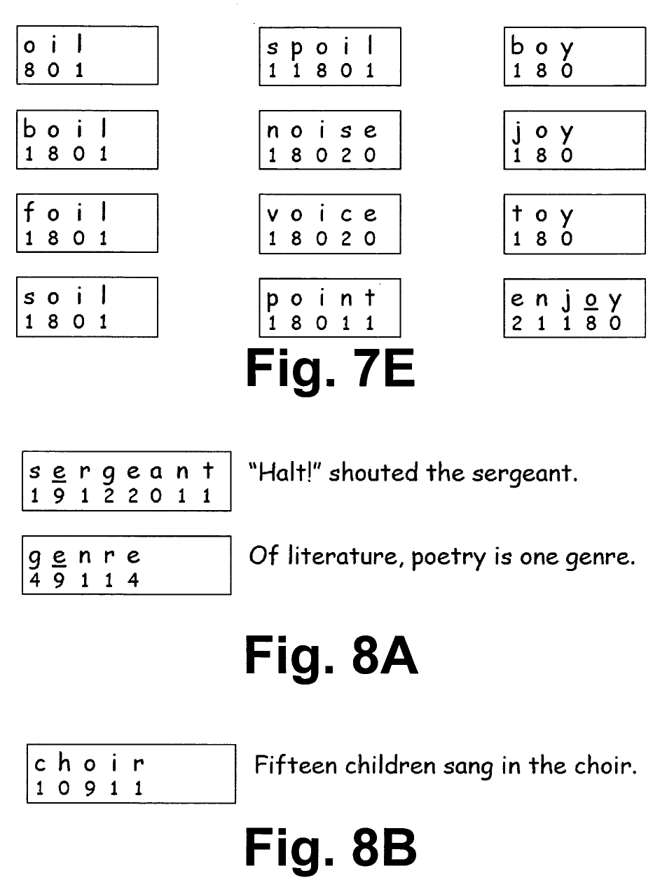

FIG. 7A through 7C show examples of the prevalence level association with a variety of words. FIG. 7A shows prevalence level 1 for the words “ate”, “like”, “board”, and “feed”. Zero under the letter “e” in “ate” and “like” represent an absence of sound and therefore not pronounced.

FIG. 7B shows prevalence levels 1 and 2 for the words “cat”, “ice”, “page”, and “give.”

FIG. 7C shows first, second, third, prevalence levels for the words “ball”, “chain”, “king”, and “laugh”. Similarly, zero prevalence level indicates no pronunciation for letters associated with zero.

FIG. 7D depicts word examples having prevalence levels 1-8 sounds for 38 words. The prevalence level numbers 102 are listed beneath the alphabet letters of the words.

FIG. 7E depicts 12 word examples of the eighth prevalence level for the number phonic O-8 of the alphabet letter O. The prevalence level numbers 102 are listed beneath the alphabet letters of the words.

FIG. 8A depicts two word examples of the ninth prevalence level for the number phonic E-9 of the alphabet letter E. The prevalence level numbers 102 are listed beneath the alphabet letters of the words. Adjacent to each word is a model word in a sample phrase. “‘Halt!’ Shouted the sergeant” is the sample phrase for the model word “sergeant”. Similarly, “Of literature, poetry is one genre” is the sample phrase for the model word “genre”. For “genre” the number phonic code sequence is 49114 for the number phonic 128A pronunciation Zip ID 127 and voice emphasis codes 128B in the number phonic order of G-4, E-9, N-1, R-1, and E-4. The number phonic order of G-4, E-9, N-1, R-1, and E-4 is associated with the pronunciation Zip ID 127 and voice emphasis codes of “sh” of “corsage”, “o” of “sergeant”, “n” of “no”, “r” of “run”, and “u” of “shovel”. The underlined letters of the model words “sergeant” and “shovel” being spoken in use voice 125A. The word “genre” is then spoken in the blended sequence of number phonic pronunciation and voice emphasis codes for “sh” of “corsage”, “o” of “sergeant”, “n” of “no”, “r” of “run”, and “u” of “shovel”.

FIG. 8B depicts a word example of the ninth prevalence level for the number phonic O-9 of the alphabet letter O. The prevalence level numbers 102 are listed beneath the alphabet letters of the word “choir” as “10911”. Choir is pronounced in order of the pronunciation and voice emphasis codes and blended.

FIG. 8 shows an example of the method 10 applied to a reading excerpt 250. The reading excerpt 250 may be select pages from books, magazines, and newspapers. Furthermore, the reading excerpts 250 may be electronic copies of books, magazines, and newspapers.

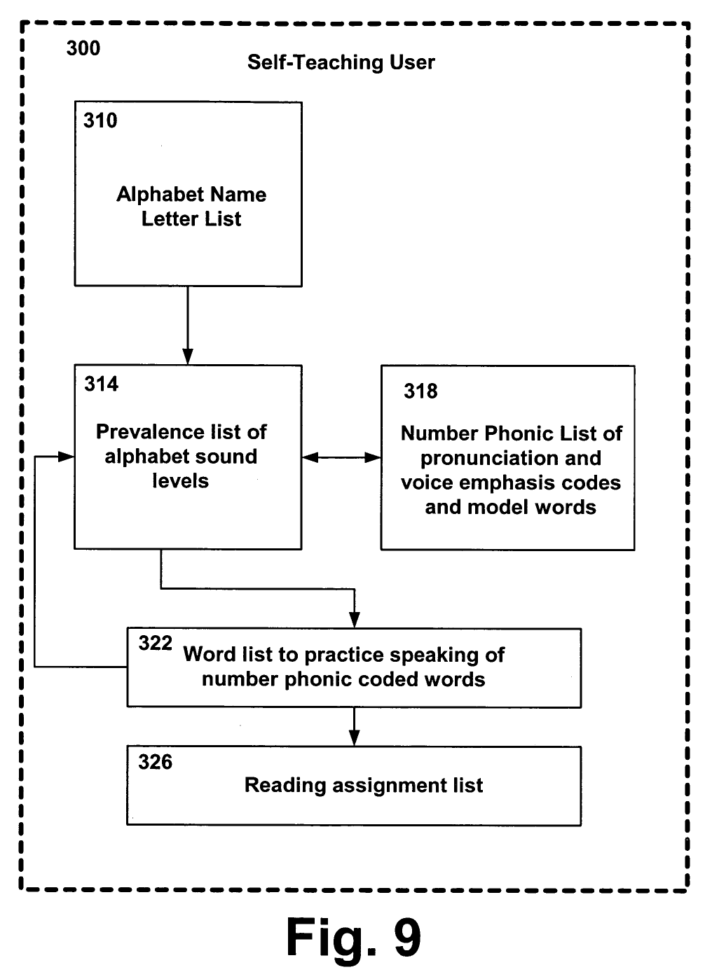

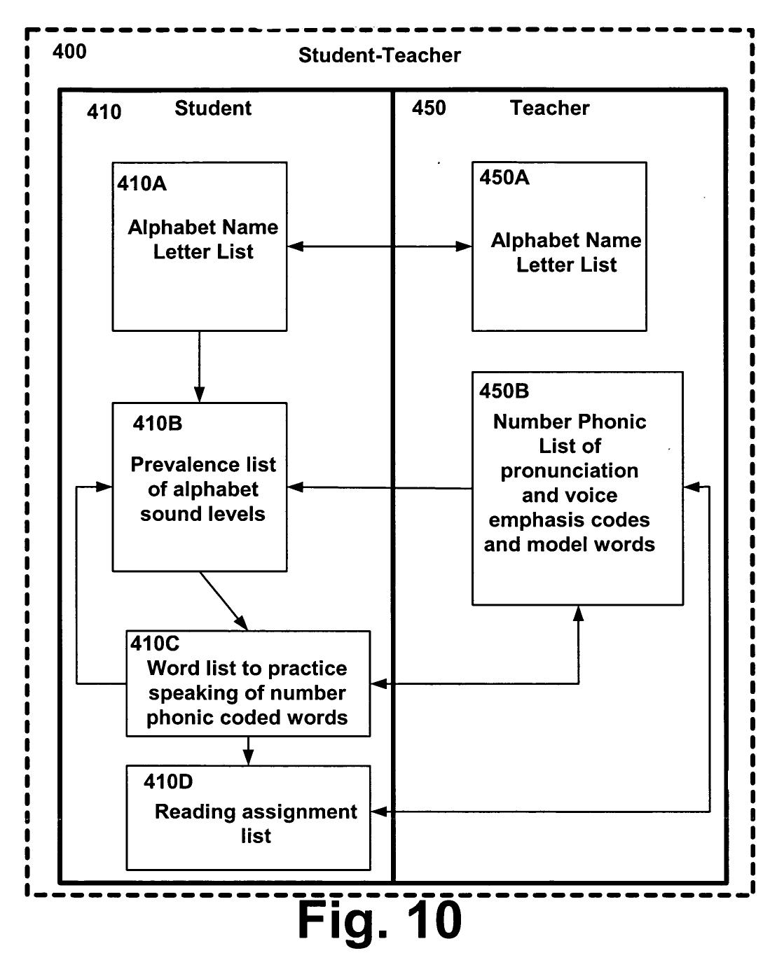

FIG. 9 is a flow diagram of a self-taught user system to teach reading 300. The system 300 includes the self-teaching user, or student, learning a list of alphabet names 310. The student then constructs a prevalence list 314 of alphabet sound levels and associates from a number phonic list 318 the pronunciation and voice emphasis codes with model words to the prevalence list 314. The prevalence list 314 is substantially similar to the speech sound level diagram 101 of the method 10. The number phonic list 318 is substantially similar to the Zip Guide 121 of the method 10. This is a two-way interaction between the prevalence list 314 and the number phonic list 318 so that the student may self-drill or commit to memory the Zip guide pronunciation 127 and voice emphasis codes 128B. Upon mastery of some of the number phonic list 318 with the prevalence list 314, the self-teaching student proceeds to practice speaking of number phonic-coded words at step 322. The student as required or desired my return to practice review of the prevalence list 314. After mastery of speaking of some the number phonic-coded words 322, the self-teaching user proceeds to applying the method 10 to a reading assignment list 326.

FIG. 10 is a flow diagram of a student-teacher system 400 to teach reading to a student 410. The system 400 depicts an interactive process between the student 410 who listens and speaks with a teacher 450. The student 410A receives and masters an alphabet name letter list 410A provided by the teacher 450 at step 450A. The student 400 interactively learns the student's letter list 410A by information exchange and drilling with the teacher 450 using the teacher's letter list 450A. The teacher 450 then arranges for the student 410 to construct a prevalence list of alphabet sound levels 410B. The prevalence list 410B is substantially similar to the speech sound level diagram 101 of the method 10. A teacher's number phonic list 450B includes pronunciation codes, voice emphasis codes, and model words. The number phonic list 450B is substantially similar to the Zip Guide 121 of the method 10. However, unlike in the self-teaching system 300, the didactic conveyance or the Zip IDs 127 is an interaction that is substantially from the teacher 450 to the student 410. That is, the association of the student's prevalence list 410B and the teacher's number phonic list 450B is substantially one way from the teacher 450 to the student 410 as regards communicating and otherwise drilling the student to learn the Zip guide 121 pronunciation Zip ID 127 and voice emphasis codes 128B of the Zip Guide 121.

The student user listens or watches the teacher reciting the pronunciation 127 and voice emphasis codes 125A-B of the Zip Guide 121 sounds, the number phonics 128A and associated example Words 128C, and the words of selected reading materials. The student 410 also listens or watches the teacher 450 reading excerpts from books, magazines, or newspapers for practicing the method 10. The teacher 450 interactively requires the student 410 to participate in enunciating words by the method 10.

Upon mastery of some of the teacher's number phonic list 450B with the student's prevalence list 410B, the student 410 proceeds to practice speaking a list of number phonic-coded words at step 410C. The student as required or desired may return to practice review of the prevalence list student's prevalence list 410B, or alternatively, practice with the teacher 450 in a two-way exchange so that the teacher 450 may assist the student 410 with speaking number phonic coded words. After mastery of speaking of some the number phonic-coded words at step 410C, the student 410 proceeds to applying the method 10 to a reading assignment list 410D. The teacher 450 may assist the student 410 with mastering the speaking of the reading assignment list 410D.

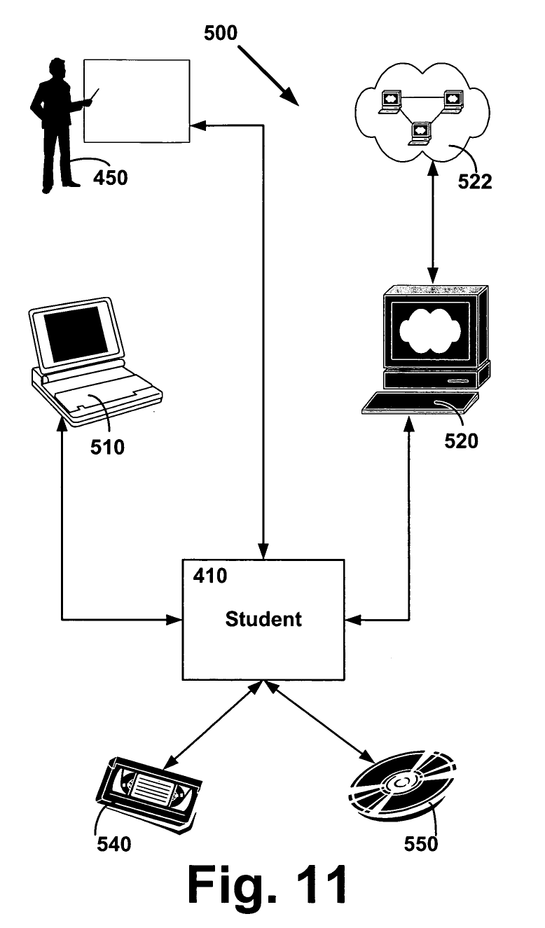

FIG. 11 is a block diagram of a system 500 to teach reading using multiple embodiments. Here the student 410 is shown interacting with the teacher 450 in a classroom situation or as individually instructed. Other embodiments include the student 410 using a computer 510 running software configured to present the method 10, or alternatively with a network computer 522 in communication with the Internet 522, wherein the reading method 10 is presented to the student 410. Another embodiment shows the student 410 using a videotape media 540 and a CD media configured with the reading method 10.

While the preferred embodiment of the invention has been illustrated and described, as noted above, many changes can be made without departing from the spirit and scope of the invention. For example, this invention may be applied to other languages besides English. The systems 300 and 400 employ the method 10 using analog (audio and video tape) and digital data systems (microprocessor-based computers and personal data assistants) configured to deliver voice and visual-voice presentations.

The speech sounds of the Zip Guide 127 may be stored on recordable media for playback by a self-teaching user. The recordable media includes audio and video. The recordable media includes and is not limited to audio tape, audio CD, video tape, CD-ROM, DVD, DVD-ROM, hard drives, floppy drives, and flash card storage media.

In the audio media, the student or user hears the speaking of pronunciation codes 127 and the voice emphasis codes 125A-B from the Zip Guide 121 depicted in FIG. 4A. Furthermore, the student or user hears the example or model words 128C for the number phonics 128A depicted in FIGS. 4B-F spoken by a person or otherwise recorded by a voice synthesizer.

In the video media, a user listens or watches an instructor or a depiction of an instructor or teacher reciting the pronunciation 127 and voice emphasis codes 125A-B of the Zip Guide 121 sounds, the number phonics 128A and associated example Words 128C, and the words of selected reading materials. The video media may also show reading excerpts from books, magazines, or newspapers for practicing the method 10. Accordingly, the scope of the invention is not limited by the disclosure of the preferred embodiment. Instead, the invention should be determined entirely by reference to the claims that follow.

1. A method comprising:
generating a table having a plurality of cells, each cell being addressed by a column heading and a row heading, wherein one of the row or column headings are associated with letters in the alphabet and one of the row or column headings are associated with prevalence levels, and
populating one or more cells in the table with phonic pronunciations associated with the addressed column and row headings.

2. The method of claim 1, wherein the prevalence levels comprises a usage frequency of the phonic pronunciations for the letters in the alphabet.

3. The method of claim 1, wherein the cells include voice emphasis codes.

4. The method of claim 3, wherein voice emphasis codes include voice and no voice.

5. The method of claim 4, wherein the voice emphasis codes are identified by at least one of a shade, color, or symbol.

6. The method of claim 1, wherein the phonic pronunciations further comprises alphabet letter sounds of the English language alphabet.

7. The method of claim 4, wherein the alphabet letter sounds further comprises the pronunciations:
a. A, a, o, u, e, O, i, and ow for alphabet letter “a”;
b. b for alphabet letter “b”;
c. k, s, ch and sh for the alphabet letter “c”;
d. d, t, and j for the alphabet letter “d”;
e. E, e, oo, u, U, A, i, O, and o for the alphabet letter “e”;
f. f and v for the alphabet letter “f”;
g. g, j, f, and sh for the alphabet letter “g”;
h. h for the alphabet letter “h”;
i. I, i, E, y, and a for the alphabet letter “i”;
j. j for the alphabet letter “j”;
k. k for the alphabet letter “k”;
l. l, and r for the alphabet letter “l”;
m. m for the alphabet letter “m”;
n. n, ng, and ny for the alphabet letter “n”;
o. O, o, oo, u, ooh, ow, I, oi, and w for the alphabet letter “o”;
p. p and f for the alphabet letter “p”;
q. k for the alphabet letter “q”;
r. r for the alphabet letter “r”;
s. s, z, sh, and sh for the alphabet letter “s”;
t. t, th, th, ch, and sh for the alphabet letter “t”;
u. U, u, oo, w, ooh, A, and i for the alphabet letter “u”;
v. v for the alphabet letter “v”;
w. w and wh for the alphabet letter “w”;
x. ks, z, ksh, and gsh for the alphabet letter “x”;
y. I, i, E and y for the alphabet letter “y”, and
z. z and ts for the alphabet letter “z”.

8. The method of claim 7, wherein the pronunciations are associated with a plurality of voice emphasis codes including voice and no voice.

9. The method of claim 8, wherein the alphabet letter sounds are further designated as number phonics comprising the row and column headings as:
a. number phonics A1-A8 for pronunciations A, a, o, u, e, O, i and ow for the alphabet letter “a” spoken in voice;
b. number phonic B1 for pronunciation b for the alphabet letter “b” spoken in no voice;
c. number phonics C1-C4 for pronunciations k, s, ch and sh for the alphabet letter “c” spoken in no voice;
d. number phonics D1-D3 for pronunciations d, and j spoken in voice and t spoken in no voice for the alphabet letter “d”;
e. number phonics E1-E9 for pronunciations E, e, oo, u, U, A, i, O, and o for the alphabet letter “e” spoken in voice;
f. number phonics F1-F2 for pronunciations f spoken in no voice and v spoken in voice for the alphabet letter “f”;
g. number phonics G1-G4 for pronunciations g, j, and sh spoken in voice and f spoken in no voice for the alphabet letter “g”;
h. number phonic H1 for pronunciation h for the alphabet letter “h” spoken in no voice;
i. number phonics H1-H5 for pronunciations I, i, E, y, and a for the alphabet letter “i” spoken in voice;
j. number phonic J1 for pronunciation j for the alphabet letter “j”;
k. number phonic K1 for pronunciation k for the alphabet letter “k” spoken in no voice;
l. number phonics L1-L2 for pronunciations l, and r for the alphabet letter “l” spoken in voice;
m. number phonic M1 for pronunciation m for the alphabet letter “m” spoken in voice;
n. number phonics N1-N3 for pronunciations n, ng, and ny for the alphabet letter “n” spoken in voice;
o. number phonics O1-O9 for pronunciations O, o, oo, u, ooh, ow, I, oi, and w for the alphabet letter “o” spoken in voice;
p. number phonics P1-P2 for pronunciations p and f for the alphabet letter “p” spoken in no voice;
q. number phonic Q1 for pronunciation k for the alphabet letter “q” spoken in no voice;
r. number phonic R1 for pronunciation r for the alphabet letter “r” spoken in voice;
s. number phonics S1-S4 for pronunciations s and sh spoken in no voice, and z and sh spoken in voice for the alphabet letter “s”;
t. number phonics T1-T5 for pronunciations t, th, ch, and sh spoken in no voice and sh spoken in voice for the alphabet letter “t”;
u. number phonics U1-U7 for pronunciations U, u, oo, w, ooh, A, and i for the alphabet letter “u” spoken in voice;
v. number phonic V1 for pronunciation v for the alphabet letter “v” spoken in voice;
w. number phonics W1-W2 for pronunciations w and wh for the alphabet letter “w” spoken in voice;
x. number phonics W1-W4 for pronunciations ks, ksh spoken in no voice and z, gsh spoken in voice for the alphabet letter “x”;
y. number phonics Y1-Y4 for pronunciations I, i, E and y for the alphabet letter “y” spoken in voice, and
z. number phonics Z1-Z2 for pronunciations z spoken in voice and ts spoken in no voice for the alphabet letter “z”.

10. A method to teach reading comprising:
learning the alphabet letter names;
determining alphabet letter sounds;
ranking the alphabet letter sounds by prevalence level;
assigning a pronunciation code to the prevalence level;
assigning a voice code to the pronunciation code;
associating the pronunciation and voice coded sounds to the letters of a word; and
enunciating the word by the sequence of pronunciation and voice codes associated with the word's letters.

11. The method of claim 10, wherein ranking the alphabet letter sounds by prevalence comprises listing the frequency of sounds in a decreasing order of occurrence.

12. The method of claim 10, wherein the alphabet letter sounds comprises 87 sounds for the 26 alphabet letters of the English language.

13. The method of claim 12, wherein the 87 sounds further comprises the pronunciations:
a. A, a, o, u, e, O, and i, ow for alphabet letter “a”;
b. b for alphabet letter “b”;
c. k, s, ch and sh for the alphabet letter “c”;
d. d, t, and j for the alphabet letter “d”;
e. E, e, oo, u, U, A, i, O, and o for the alphabet letter “e”;
f. f and v for the alphabet letter “f”;
g. g, j, f, and sh for the alphabet letter “g”;
h. h for the alphabet letter “h”;
i. I, i, E, y, and a for the alphabet letter “i”;
j. j for the alphabet letter “j”;
k. k for the alphabet letter “k”;
l. l, and r for the alphabet letter “l”;
m. m for the alphabet letter “m”;
n. n, ng, and ny for the alphabet letter “n”;
o. O, o, oo, u, ooh, ow, I, oi, and w for the alphabet letter “o”;
p. p and f for the alphabet letter “p”;
q. k for the alphabet letter “q”;
r. r for the alphabet letter “r”;
s. s, z, sh, and sh for the alphabet letter “s”;
t. t, th, th, ch, and sh for the alphabet letter “t”;
U. U, u, oo, w, ooh, A, and i for the alphabet letter “u”;
v. v for the alphabet letter “v”;
w. w and wh for the alphabet letter “w”;
x. ks, z, ksh, and gsh for the alphabet letter “x”;
y. I, i, E and y for the alphabet letter “y”, and
z. z and ts for the alphabet letter “z”.

14. The method of claim 13, wherein the alphabet letter sounds are spoken in a plurality of voices including voice and no voice.

15. The method of claim 14, wherein the alphabet letter sounds are further designated as number phonics comprising the row and column headings as:
a. number phonics A1-A8 for pronunciations A, a, o, u, e, O, i and ow for the alphabet letter “a” spoken in voice;
b. number phonic B1 for pronunciation b for the alphabet letter “b” spoken in no voice;
c. number phonics C1-C4 for pronunciations k, s,ch and sh for the alphabet letter “c” spoken in no voice;
d. number phonics D1-D3 for pronunciations d, and j spoken in voice and t spoken in no voice for the alphabet letter “d”;
e. number phonics E1-E9 for pronunciations E, e, oo, U, U, A, i, O, and o for the alphabet letter “e” spoken in voice;
f. number phonics F1-F2 for pronunciations f spoken in no voice and v spoken in voice for the alphabet letter “f”;
g. number phonics G1-G4 for pronunciations g, j, and sh spoken in voice and f spoken in no voice for the alphabet letter “g”;
h. number phonic H1 for pronunciation h for the alphabet letter “h” spoken in no voice;
i. number phonics H1-H5 for pronunciations I, i, E, y, and a for the alphabet letter “i” spoken in voice;
j. number phonic J1 for pronunciation j for the alphabet letter “j”;
k. number phonic K1 for pronunciation k for the alphabet letter “k” spoken in no voice;
l. number phonics L1-L2 for pronunciations l, and r for the alphabet letter “l” spoken in voice;
m. number phonic M1 for pronunciation m for the alphabet letter “m” spoken in voice;
n. number phonics N1-N3 for pronunciations n, ng, and ny for the alphabet letter “n” spoken in voice;
o. number phonics O1-O9 for pronunciations O, o, oo, u, ooh, ow, I, oi, and w for the alphabet letter “o” spoken in voice;
p. number phonics P1-P2 for pronunciations p and f for the alphabet letter “p” spoken in no voice;
q. number phonic Q1 for pronunciation k for the alphabet letter “q” spoken in no voice;
r. number phonic R1 for pronunciation r for the alphabet letter “r” spoken in voice;
s. number phonics S1-S4 for pronunciations s and sh spoken in no voice, and z and sh spoken in voice for the alphabet letter “s”;
t. number phonics T1-T5 for pronunciations t, th, ch, and sh spoken in no voice and sh spoken in voice for the alphabet letter “t”;
u. number phonics U1-U7 for pronunciations U, u, oo, w, ooh, A, and i for the alphabet letter “u” spoken in voice;
v. number phonic V1 for pronunciation v for the alphabet letter “v” spoken in voice;
w. number phonics W1-W2 for pronunciations w and wh for the alphabet letter “w” spoken in voice;
x. number phonics W1-W4 for pronunciations ks, ksh spoken in no voice and z, gsh spoken in voice for the alphabet letter “x”;
y. number phonics Y1-Y4 for pronunciations I, i, E and y for the alphabet letter “y” spoken in voice, and
z. number phonics Z1-Z2 for pronunciations z spoken in voice and ts spoken in no voice for the alphabet letter “z”.

16. A system to teach reading comprising:
a tabular list having a plurality of cells, each cell being addressed by a column heading and a row heading, wherein one of the row or column headings are associated with letters in the alphabet and one of the row or column headings are associated with prevalence levels, the cells further populated with one or more phonic pronunciations associated with the addressed column and row headings, the phonic pronunciations further associated with a voice code;
wherein the letters of a word are associated to the prevalence level and the word enunciated by speaking the sequence of prevalence level pronunciation and voice codes associated with the word's letters.

17. The system of claim 16, wherein ranking the prevalence levels are arranged from the most common to the least common occurrence.

18. The system of claim 16, wherein the alphabet letter sounds comprises 87 sounds for the 26 alphabet letters of the English language.

19. The system of claim 18, wherein the 87 sounds further comprises the pronunciations:
a. A, a, o, u, e, O, i, and ow for alphabet letter “a”;
b. b for alphabet letter “b”;
c. k, s, ch and sh for the alphabet letter “c”;
d. d, t, and j for the alphabet letter “d”;
e. E, e, oo, u, U, A, i, O, and o for the alphabet letter “e”;
f. f and v for the alphabet letter “f”;
g. g, j, f, and sh for the alphabet letter “g”;
h. h for the alphabet letter “h”;
i. I, i, E, y, and a for the alphabet letter “i”;
j. j for the alphabet letter “j”;
k. k for the alphabet letter “k”;
l. l, and r for the alphabet letter “l”;
m. m for the alphabet letter “m”;
n. n, ng, and ny for the alphabet letter “n”;
o. O, o, oo, u, ooh, ow, I, oi, and w for the alphabet letter “o”;
p. p and f for the alphabet letter “p”;
q. k for the alphabet letter “q”;
r. r for the alphabet letter “r”;
s. s, z, sh, and sh for the alphabet letter “s”;
t. t, th, th, ch, and sh for the alphabet letter “t”;
u. U, u, oo, w, ooh, A, and i for the alphabet letter “u”;
v. v for the alphabet letter “v”;
w. w and wh for the alphabet letter “w”;
x. ks, z, ksh, and gsh for the alphabet letter “x”;
y. I, i, E and y for the alphabet letter “y”, and
z. z and ts for the alphabet letter “z”.

20. The system of claim 19, wherein the alphabet letter sounds are spoken in a plurality of voices including voice and no voice.

21. The system of claim 20, wherein the alphabet letter sounds are further designated as number phonics comprising the row and column headings as:
a. number phonics A1-A8 for pronunciations A, a, o, u, e, O, i and ow for the alphabet letter “a” spoken in voice;
b. number phonic B1 for pronunciation b for the alphabet letter “b” spoken in no voice;
c. number phonics C1-C4 for pronunciations k, s, ch and sh for the alphabet letter “c” spoken in no voice;
d. number phonics D1-D3 for pronunciations d, and j spoken in voice and t spoken in no voice for the alphabet letter “d”;
e. number phonics E1-E9 for pronunciations E, e, oo, u, U, A, i, O, and o for the alphabet letter “e” spoken in voice;
f. number phonics F1-F2 for pronunciations f spoken in no voice and v spoken in voice for the alphabet letter “f”;
g. number phonics G1-G4 for pronunciations g, j, and sh spoken in voice and f spoken in no voice for the alphabet letter “g”;
h. number phonic H1 for pronunciation h for the alphabet letter “h” spoken in no voice;
i. number phonics H1-H5 for pronunciations I, i, E, y, and a for the alphabet letter “i” spoken in voice;
j. number phonic J1 for pronunciation j for the alphabet letter “j”;
k. number phonic K1 for pronunciation k for the alphabet letter “k” spoken in no voice;
l. number phonics L1-L2 for pronunciations l, and r for the alphabet letter “l” spoken in voice;
m. number phonic M1 for pronunciation m for the alphabet letter “m” spoken in voice;
n. number phonics N1-N3 for pronunciations n, ng, and ny for the alphabet letter “n” spoken in voice;
o. number phonics O1-O9 for pronunciations 0, o, oo, u, ooh, ow, I, oi, and w for the alphabet letter “o” spoken in voice;
p. number phonics P1-P2 for pronunciations p and f for the alphabet letter “p” spoken in no voice;
q. number phonic Q1 for pronunciation k for the alphabet letter “q” spoken in no voice;
r. number phonic R1 for pronunciation r for the alphabet letter “r” spoken in voice;
s. number phonics S1-S4 for pronunciations s and sh spoken in no voice, and z and sh spoken in voice for the alphabet letter “s”;
t. number phonics T1-T5 for pronunciations t, th, ch, and sh spoken in no voice and sh spoken in voice for the alphabet letter “t”;
u. number phonics U1-U7 for pronunciations U, u, oo, w, ooh, A, and i for the alphabet letter “u” spoken in voice;
v. number phonic V1 for pronunciation v for the alphabet letter “v” spoken in voice;
w. number phonics W1-W2 for pronunciations w and wh for the alphabet letter “w” spoken in voice;
x. number phonics W1-W4 for pronunciations ks, ksh spoken in no voice and z, gsh spoken in voice for the alphabet letter “x”;
y. number phonics Y1-Y4 for pronunciations I, i, E and y for the alphabet letter “y” spoken in voice, and
z. number phonics Z1-Z2 for pronunciations z spoken in voice and ts spoken in no voice for the alphabet letter “z”.

22. The system of claim 16, wherein the list is generated on print and electronic media.

23. The system of claim 22, wherein the electronic media includes analog and digital media, the media containing audio recordings of the phonic pronunciations and voice codes.

24. The system of claim 22, wherein the electronic media includes analog and digital media, the media containing audio recordings of the phonic pronunciations and voice codes and video recordings of a person or a figure representing a person speaking the phonic pronunciations and voice codes.

25. The system of claim 24, wherein the pronunciations further include model words having the phonic pronunciations.

26. The system of claim 23 wherein the digital media is compatible for microprocessor based computers configured to run hard drives, floppy drives, CDs, CD-ROMS, DVDs, and flash memory devices.

27. The system of claim 16, wherein reading is self-taught by a user.

28. The system of claim 16 wherein reading is taught to a user by a teacher.
